(19) United States
(12) Patent Application Publication
(10) Pub. No.: US 2025/0223917 A1
(43) Pub. Date: Jul. 10, 2025

(54) COOLING ARRANGEMENT, ROCK DRILLING RIG AND METHOD OF COOLING

(71) Applicant: SANDVIK MINING AND CONSTRUCTION OY, Tampere (FI)

(72) Inventors: Jarkko JANTTI, Tampere (FI); Markus HAKALA, Tampere (FI)

(21) Appl. No.: 18/871,715

(22) PCT Filed: May 22, 2023
(86) PCT No.: PCT/EP2023/063579

§ 371 Date: Dec. 4, 2024

(30) Foreign Application Priority Data
Jun. 3, 2022 (EP) 22177261.9

(51) Int. Cl. F01P 3/18; E21B 7/02; F01P 3/20; F15B 21/0423

(52) U.S. Cl. CPC F01P 3/18; E21B 7/023; F01P 3/20; F15B 21/0423

(57) ABSTRACT

A cooling arrangement, a mining vehicle, and a method for providing cooling in a mine vehicle is provided. The mining vehicle includes a combustion engine arranged to execute tramming, a hydraulic system arranged for powering at least one hydraulic actuator, and an electrically operable powerpack arranged for powering the hydraulic system. The cooling arrangement has a first liquid cooling circuit arranged for cooling the combustion engine and a second liquid cooling circuit arranged for cooling hydraulic oil. The second liquid cooling circuit is selectively connectable to the first liquid cooling circuit when the combustion engine is off.

### BACKGROUND OF THE INVENTION

The invention relates to a cooling arrangement of a mining vehicle.

The invention further relates to a rock drilling rig and to a method for cooling in a mining vehicle.

The field of the invention is defined more specifically in the preambles of the independent claims.

In mines and at other work sites different type of mining vehicles are used. The mining vehicles may be provided with diesel engines for producing needed power for tramming the mining vehicles between work sites and target positions, and electrically operable power packages for executing actual work tasks at the work sites. The electric power packages are arranged to provide power for hydraulic systems and hydraulic mining actuators connected to the hydraulic systems. Hydraulic oil of the hydraulic system may get overheated during the operation if being not properly cooled. Therefore, different cooling arrangements and oil coolers are disclosed for cooling the hydraulic oil of the hydraulic system. However, the known solutions have shown some disadvantages.

### BRIEF DESCRIPTION OF THE INVENTION

An object of the invention is to provide a novel and improved cooling arrangement and method. A further object is to provide a rock drilling rig provided with a novel and improved cooling system.

The cooling arrangement according to the invention is characterized by the characterizing features of the first independent apparatus claim.

The rock drilling rig according to the invention is characterized by the characterizing features of the second independent apparatus claim.

The method according to the invention is characterized by the characterizing features of the independent method claim.

An idea of the disclosed solution is that a first liquid cooling circuit of the combustion engine of a mine vehicle is utilized for cooling a second liquid cooling circuit intended for cooling hydraulic fluid of a hydraulic system. Further, the disclosed solution is a cooling arrangement for the mining vehicle comprising: a combustion engine for execute tramming, the hydraulic system for powering at least one hydraulic actuator, and an electrically operable powerpack for powering the hydraulic system. The first liquid cooling circuit for cooling the combustion engine comprises at least one first radiator provided with a fan, and a first pump unit for circulating coolant agent between the combustion engine and the first radiator. The second liquid cooling circuit can be selectively connected to the first liquid cooling circuit so that the same cooling agent, the same first radiator and the same fan are implemented in both liquid cooling circuits. The second liquid cooling circuit further comprises an oil cooler being a liquid to liquid cooler for transforming heat of the hydraulic oil to the coolant agent of the liquid cooling circuits. The coolant agent is circulated in the second liquid cooling circuit only when the combustion engine is not operating. In other words, the hydraulic oil of the hydraulic system is cooled by the second liquid cooling circuit which is connectable to the first liquid cooling circuit of the combustion engine in situations when the combustion engine is not running and needs no cooling. Thus, two closed liquid cooling systems can be selectively connected.

An advantage of the disclosed solution is that the effective cooling circuit of the combustion engine can be utilized when there is no need for cooling the combustion engine. This way effective hydraulic oil cooling is achieved and the hydraulic system can be driven with high power and long operating periods without the risk of overheated hydraulic oil.

A further advantage is that the second cooling circuit for cooling the hydraulic oil can be relatively simple and inexpensive. Connection to the first cooling circuit of the combustion engine is also simple to arrange and control.

Further, the disclosed solution uses the large sized radiator dimensioned for cooling the combustion engine, and when the engine is off, this large cooling area of the radiator can be utilized exclusively for cooling the second liquid cooling circuit. This way the hydraulic oil can be cooled effectively.

According to an embodiment, the cooling agent or coolant is water based liquid. The cooling agent may be a mix of glycol and water. The glycol may be ethylene glycol.

According to an embodiment, the cooling arrangement comprises only one radiator. The radiator and its entire cooling area are common for the first and second liquid cooling circuits.

According to an embodiment, the second liquid cooling circuit is connectable directly to the radiator of the first liquid cooling circuit. In other words, the radiator has own ports for both circuits.

According to an embodiment, the second liquid cooling circuit is connectable by means of tube or hose elements to flow paths of the first liquid cooling circuit. In this solution the second liquid cooling circuit is not connected directly to the radiator.

According to an embodiment, the cooling arrangement may comprise a second radiator in connection with the first radiator. Hydraulic oil cooled in the oil-coolant exchanger, i.e., in the oil cooler, is conveyed to the second radiator for further cooling. The second radiator is cooled by the fan of the first radiator. This way two phased hydraulic oil cooling is achieved.

According to an embodiment, the cooling arrangement may comprise a third radiator in connection with the first radiator. The third radiator is a charge air cooler for cooling air fed to the combustion engine.

According to an embodiment, the cooling arrangement may comprise a fourth radiator in connection with the first radiator. The fourth radiator is an oil cooler, for cooling hydraulic oil of a hydrostatic power transmission for tramming. During the tramming temperature of the hydraulic oil rises and needs to be cooled. When the mining vehicle is not trammed and the combustion engine is off, the fan of the first radiator is operating for cooling the second liquid cooling circuit whereby the fan also cools the fourth radiator. This way the hydraulic oil of the hydrostatic power transmission can also be cooled during a rock drilling sequence or another mining work cycle when the mining vehicle is not moved.

Further, it may also be possible to implement the second liquid cooling circuit for cooling the hydraulic oil of the power transmission in a substantially similar manner as for cooling the basic hydraulic system intended for actuating the hydraulic mining work actuators.

According to an embodiment, the cooling arrangement may comprise a fifth radiator in connection with the first radiator. The third radiator is an oil cooler for cooling motor oil of the combustion engine, for example.

According to an embodiment, the cooling arrangement may comprise several radiators cooled by the same fan. This kind of radiator configuration may be named as a combi cooler.

According to an embodiment, the cooling arrangement comprises only one oil cooling device for cooling the hydraulic oil. Thus, no oil-air exchangers or additional oil-water heat exchangers are needed due to the disclosed effective second liquid cooling circuit.

According to an embodiment, the at least one hydraulic actuator connected to the hydraulic system is a hydraulic mining actuator, such as a hydraulic rock drilling machine, or a rock bolting device.

According to an embodiment, the second liquid cooling circuit may be connected to cool only one oil cooler or there may be two or more oil coolers connected to the second liquid cooling circuit.

According to an embodiment, the cooling arrangement comprises at least one control unit for automatic control of the second liquid cooling circuit. The control unit is provided with sensing data for indicating operating status of the combustion engine. Further, the control unit controls the second cooling mode on and off in response to the sensing data to control the second cooling circuit. In other words, the second liquid cooling circuit is automatically controlled under pre-determined or input control strategy.

According to an embodiment, the second liquid cooling circuit can be cooled when one or more hydraulic actuators of the hydraulic system are operated and temperature of the hydraulic fluid raises. The temperature of the hydraulic oil can be monitored by means of one or more temperatures sensors. The monitoring data is transmitted to the control unit and the second liquid cooling circuit can be cooled when needed.

According to an embodiment, the control system of the second liquid cooling circuit comprises an input control strategy according to which the second liquid cooling circuit is cooled also in situations when hydraulic oil is circulated in the hydraulic system even though no hydraulic actuators connected to the hydraulic system are not active. The control unit may switch the hydraulic pump on for circulating the hydraulic oil in the system. This way, the cooling system can extend cooling time for cooling the hydraulic liquid. Then cooling efficiency is improved. This is a kind of full-time cooling utilized when the combustion engine is off.

According to an embodiment, the hydraulic pump may alternatively be kept continuously running during the operation even though no hydraulic actuators connected to the hydraulic system are active. Then, the control unit is configured to switch on and off the circulation pump unit for circulating the cooling agent in the second liquid cooling circuit in accordance with the principles disclosed in this document.

According to an embodiment, the second liquid cooling circuit can be cooled in advance prior to operation of the hydraulic actuators. When the temperature of the hydraulic oil is set to a lower level, the hydraulic system will tolerate heavy loadings during the following work cycles. The control unit may control cooling of the second liquid cooling circuit at all suitable situations when the combustion engine is not running. The control unit may be provided with data on following work cycles and operations whereby the control unit can estimate or calculate the amount of the needed pre-cooling based on that data.

According to an embodiment, the second liquid cooling circuit can alternatively be controlled manually by means of an operator of the mining vehicle.

According to an embodiment, the second liquid cooling circuit comprises at least one control valve for opening and closing circulation of the second liquid cooling circuit to the radiator. In other words, the circulation in the second liquid cooling circuit can be completely stopped by the control valve when the combustion engine is cooled. This is advantageous since temperature of the cooling agent after the running combustion engine may be almost 100° C. which is significantly higher compared to normal operating temperature (under 75° C.) of the hydraulic oil. Then the high temperature cooling agent cannot influence the temperature of the hydraulic oil.

According to an embodiment, number of the control valves is one. In an alternative solution, there are two control valves for controlling the circulation. The control valves can also be called as separation valves.

According to an embodiment, the one or more control valves are electrically operable valves and are controlled under control of the mentioned control unit.

According to an embodiment, the one or more control valves are on/off-valves.

According to an embodiment, actuators of the second liquid cooling circuit can be controlled either using on/off control or proportional control. The proportional control allows adjusting flow in the circuit. The controllable actuators may be valves and pumps.

According to an embodiment, the second liquid cooling circuit may be without any control valve for opening and closing circulation of the second liquid cooling circuit to the radiator. Instead, there may be a circulation pump operation of which is configured to serve as a circulation preventing element when being stopped. Thus, the circulation pump may be liquid tight when not operating. In other words, the circulation pump can serve both as a pumping device and a valve element. Then, number of components in the system can be reduced.

According to an embodiment, the fan of the first radiator comprises a dedicated fan motor and is operable independently in relation to the operation of the combustion engine. In other words, the fan is not mechanically coupled to the combustion engine whereby running of the fan is not dependent on running of the combustion engine.

According to an embodiment, the fan motor is a hydraulic motor connected to the hydraulic system.

According to an embodiment, the fan motor is an electrical motor.

According to an embodiment, the fan motor is controlled under control of the control unit.

According to an embodiment, the second liquid cooling circuit comprises at least one dedicated circulation pump unit for circulating the cooling agent in the second liquid cooling circuit. In other words, the second liquid cooling circuit comprises a pump of its own whereby circulation of the cooling agent is independent of the pump of the first liquid cooling circuit. A further advantage of this solution is that flow rate can be adjusted by the circulation pump unit whereby cooling power can be adjusted in a versatile manner.

According to an embodiment, the circulation pump unit comprises an electrical motor and a pump. The electrical motor can be controlled under control of the control unit.

According to an embodiment, the motor of the circulation pump unit may alternatively be a hydraulic motor.

According to an embodiment, the first pump unit is arranged to provide liquid flow for both liquid cooling circuits. Thus, there may only one pump for circulating the liquid cooling agent.

According to an embodiment, the at least one oil cooler for cooling hydraulic oil of the hydraulic system is a shell and tube type oil cooler. In other words, the oil cooler comprises a liquid cooled space between the outer shell and several tubes inside which tubes the oil flows. The oil cooler is typically a heat exchanger.

According to an embodiment, also other type of hydraulic oil to cooling agent exchangers can be utilized. Thus, the oil cooler may alternatively be a plate heat exchanger, for example.

According to an embodiment, the at least one oil cooler for cooling hydraulic oil of the hydraulic system is a heat exchanger. It is possible to use the oil cooler also to transmit heat from the liquid cooling agent to the hydraulic oil and to thereby heat the hydraulic system when operating in cold circumstances. This possibility allows to pre-heat the hydraulic system.

According to an embodiment, the disclosed solution relates to a rock drilling rig comprising: a movable carrier; a combustion engine and a transmission system for tramming the rock drilling rig; a drilling boom mounted on the carrier and comprising a rock drilling unit provided with a hydraulic rock drilling machine; a hydraulic system for powering at least hydraulic actuators of the rock drilling machine; an electrically operable powerpack for powering at least the hydraulic system; and a cooling arrangement for cooling the combustion engine and hydraulic oil of the hydraulic system. The cooling arrangement comprises a second liquid cooling circuit for cooling the hydraulic oil and being connectable to a first liquid cooling system of the combustion engine whereby the cooling arrangement is configured to provide cooling alternately for the combustion engine or the hydraulic system. The cooling arrangement is in accordance with the features and embodiments disclosed in this document.

According to an embodiment, the disclosed solution relates to a method for providing cooling in a mine vehicle. The method comprises: cooling a combustion engine of the mine vehicle by means of a first liquid cooling circuit; and cooling hydraulic oil of a hydraulic system of the mine vehicle by means of at least one oil cooler. The method further comprises: connecting the at least one oil cooler to a second liquid cooling circuit; connecting the second liquid cooling circuit selectively to the first liquid cooling circuit in situations when the combustion engine requires no cooling and utilizing thereby cooling area of a radiator of the first liquid cooling circuit for cooling the hydraulic oil.

According to an embodiment, the method further comprises adjusting flow rate of cooling agent in the second liquid cooling circuit by means of a dedicated circulation pump unit of the second liquid cooling circuit.

According to an embodiment, the method further comprises preventing circulation of cooling agent in the second liquid cooling circuit when the combustion engine is running.

According to an embodiment, the method further comprises pre-cooling the hydraulic oil prior to initiate operation of at least one hydraulic actuator of the hydraulic system.

According to an embodiment, the method further comprises utilizing a common radiator and a common fan for executing cooling of the combustion engine and the oil cooler.

According to an embodiment, the method further comprises running a common fan of the first and second liquid cooling circuit independently of operation of the combustion engine.

According to an embodiment, the second cooling mode is selectable when the combustion engine is not running and does not need the cooling. When the second cooling mode is selected on, then the control unit can control actuators of the second liquid cooling circuit thereby initiating the actual cooling measures in the circuit. The cooling measures in the second cooling circuit can be triggered by means of temperature data of the cooling agent, temperature data on hydraulic oil, or both, for example. However, other sensing and control data, as well as control principles, can also be utilized for executing the triggering. The control unit may be provided with data on status of the hydraulic circuit i.e., whether the hydraulic circuit is on or off. In other words, the cooling in the second liquid cooling circuit is not initiated automatically when the combustion engine stops, but dedicated control steps are needed.

The above disclosed embodiments may be combined to form suitable solutions having those of the above features that are needed.

### BRIEF DESCRIPTION OF THE FIGURES

Some embodiments are described in more detail in the accompanying drawings, in which

FIG. 1 is a schematic side view of a rock drilling rig for underground drilling and being provided with a cooling arrangement,

FIG. 2 is a schematic diagram of some features of a cooling arrangement,

FIG. 3 is a schematic view of a cooling arrangement when a first cooling mode is on and a combustion engine is being cooled,

FIG. 4 is a schematic view of the cooling arrangement shown in FIG. 3 in a situation when a second cooling mode is connected and a hydraulic system is being cooled, and

FIGS. 5-7 are schematic views of alternative cooling arrangements.

For the sake of clarity, the figures show some embodiments of the disclosed solution in a simplified manner. In the figures, like reference numerals identify like elements.

### DETAILED DESCRIPTION OF SOME EMBODIMENTS

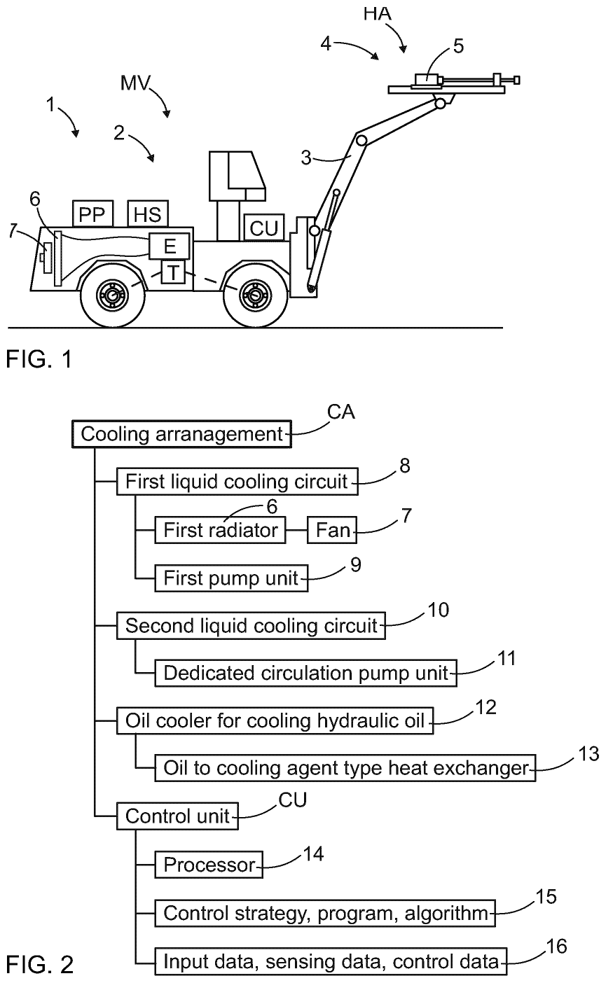

FIG. 1 discloses a rock drilling rig 1 comprising a movable carrier 2. The rock drilling rig 1 is one example of a mining vehicle MV. One or more drilling booms 3 are mounted on the carrier 2. Each of the booms 3 may comprise a rock drilling unit 4 provided with a hydraulic rock drilling machine 5. There is a hydraulic system HS for powering hydraulic actuators HA of the rock drilling machine 5, such as a hydraulic impact device and hydraulic rotation device. There may also be other hydraulic actuators, such as a feed device and boom cylinders, connected to the hydraulic system HS. A combustion engine E and a transmission system T are arranged on the carrier 2 to be used for tramming the rock drilling rig 1 between work sites and to other locations. The transmission system T may comprise a mechanical gear system and transmission elements, or it may alternatively comprise hydrostatic transmission elements. The combustion engine E is running only when tramming the rig 1 and is off when executing the drilling measures. Therefore, the carrier 2 is provided with an electrically operable powerpack PP for powering at least the hydraulic system HS and providing hydraulic power for the hydraulic actuators.

Further, the combustion engine E and hydraulic oil of the hydraulic system HS are cooled by means of a cooling arrangement based on closed cooling agent circulation. For simplicity reasons FIG. 1 discloses only some features of the cooling arrangement. There is a radiator 6 and a fan 7 cooling the cooling agent. FIG. 1 also discloses some fluid channels or tubes for circulating the cooling agent between the radiator 6 and the combustion engine E. The cooling arrangement can be controlled by means of one or more control units CU. The cooling arrangement is in accordance with the features and embodiments disclosed in this document.

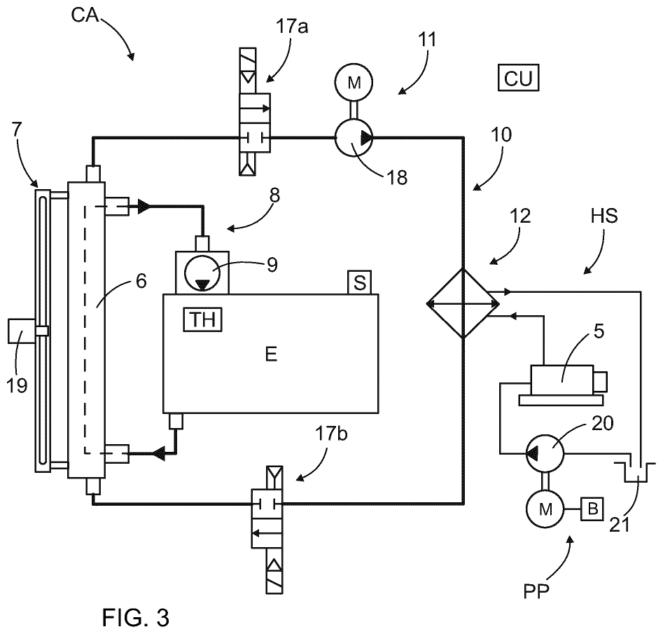

FIG. 2 discloses some features of a cooling arrangement CA. The cooling arrangement CA comprises a first liquid cooling circuit 8 for cooling the combustion engine E and comprising at least one first radiator 6 provided with a fan 7. A first pump unit 9 is arranged to circulate coolant agent between the combustion engine E and the first radiator 6. The cooling arrangement CA also comprises a second liquid cooling circuit 10 selectively connectable to the first liquid cooling circuit 8 whereby the same cooling agent, the first radiator 6 and the fan 7 are implemented in both liquid cooling circuits 8, 10. The second liquid cooling circuit 10 comprises one or more dedicated circulation pump units 11 for circulating the cooling agent in the second liquid cooling circuit 10. The second liquid cooling circuit 10 may also comprise means for blocking circulation when the combustion engine is running. There is also one or more oil coolers 12 for cooling hydraulic oil of the hydraulic system. The oil cooler is a liquid to liquid cooler 13 connected to the second liquid cooling circuit 10 whereby heat of the hydraulic oil is transformed via the oil cooler 13 to the coolant agent. The cooling arrangement CA comprises one or more control units CU for automatic control of the second liquid cooling circuit 10. The control unit CU is provided with a processor 14 for executing control measures under control strategies, programs, and algorithms 15 input to the control unit CU. Input data, sensing data and control data 16 may also be input to the control unit CU. The input data may comprise sensing data on indicating operating status of the combustion engine, for example.

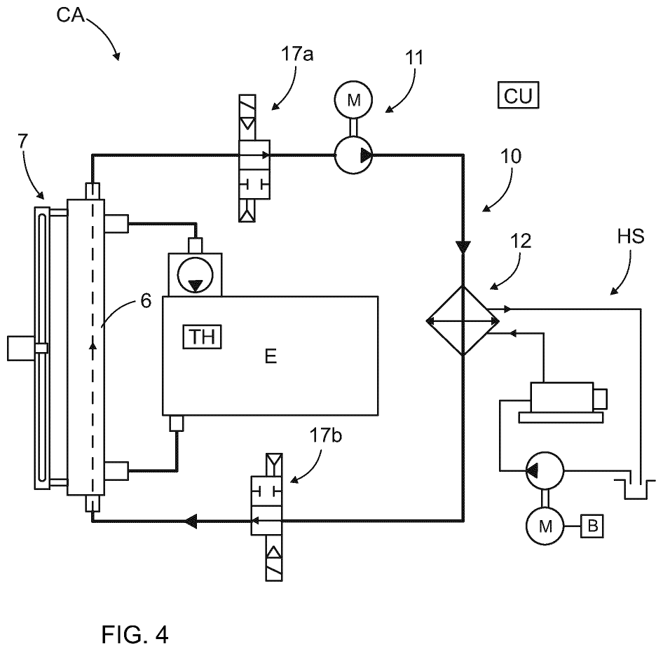

FIG. 3 discloses a cooling arrangement CA comprising a first liquid cooling circuit 8 for cooling a combustion engine E. A first pump unit 9 circulates cooling agent between the combustion engine E and a first radiator 6 when the combustion engine E is running. This situation is shown in FIG. 3. Circulation of the same cooling agent in a second liquid cooling circuit 10 is prevented by means of control valves 17a and 17b, which may be electrically operable valves controlled by a control unit CU. Fluid flow in the second liquid cooling circuit 10 is formed by a dedicated circulation pump unit 11, or second pump unit, comprising a pump 18 and a motor M. The motor M may be an electrically operable motor and it may be controlled by the control unit CU. In FIG. 3 the control valves 17a, 17b are closed and the circulation pump unit 11 is not running whereby the cooling agent flows only in the first liquid cooling circuit 8.

The control unit CU may receive sensing data from a sensor S indicating operational state of the combustion engine. In FIG. 3 the control unit CU executes a first cooling mode for circulating the coolant agent in the first liquid cooling circuit 8 in response to detection that the combustion engine E is operating.

The control unit CU may also be provided with other sensing data, such as temperature data on the combustion engine and liquid cooling agent.

The control unit CU may also control a motor 19 of the fan 7 for adjusting cooling power of the first radiator 6.

FIG. 3 further discloses a hydraulic system HS connected to an oil cooler 12 for cooling hydraulic oil of the hydraulic system HS. Pressure and flow in the hydraulic system HS is generated by a hydraulic pump 20 driven by an electrical motor M. The motor M is powered by a battery B. Alternatively, there may a connection to an external electric power source. Thus, there is an electrical power pack PP for operating the hydraulic system HS independently of the combustion engine E. A mining actuator, such as a rock drilling machine 5 is connected to the hydraulic system HS. Hydraulic fluid gets heated in the rock drilling machine 5 and is therefore conveyed via the oil cooler 12 to a tank 21.

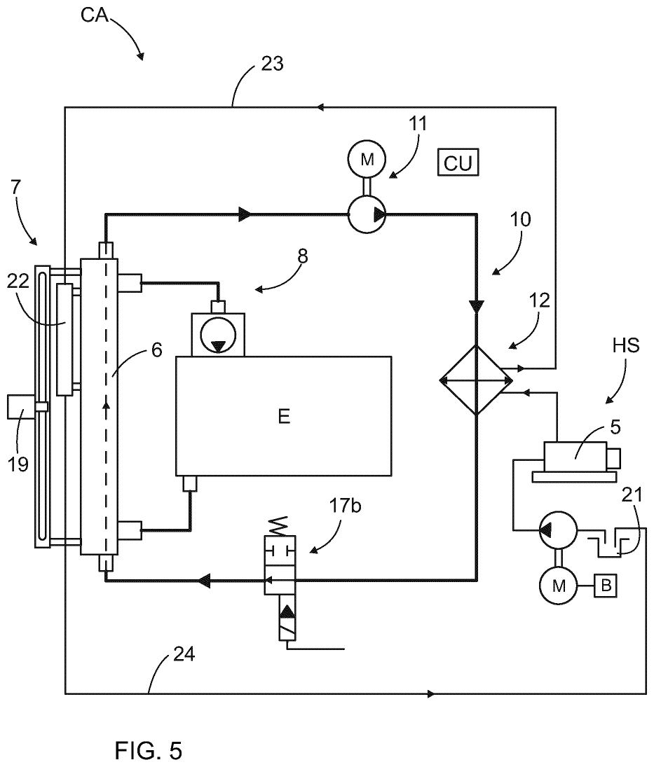

FIG. 4 discloses the same cooling arrangement CA as in FIG. 3 but in a situation where the combustion engine E is stopped and needs no cooling. Then, the second liquid cooling circuit 10 is activated by the control unit CU by opening the control valves 17a, 17b and running the dedicated circulation pump unit 11. The fan 7 cools the cooling agent inside the radiator 6 and the cooled cooling agent, such as a water mix, flows to the oil cooler 12, or exchanger.

FIGS. 3 and 4 disclose that the combustion engine E comprises a thermostat TH, which is normally closed and opens when temperature of the cooling agent rises to set temperature and then allows the cooled cooling agent to pass the channels in the combustion engine E. When the combustion engine E is not running the temperature of the cooling agent is below the set temperature and the thermostat TH is closed. In other words, the thermostat TH prevents flow through the combustion engine E when the second liquid cooling circuit 10 is operative. However, it is possible to use any other flow control valves or elements selectively blocking the flow through the engine E.

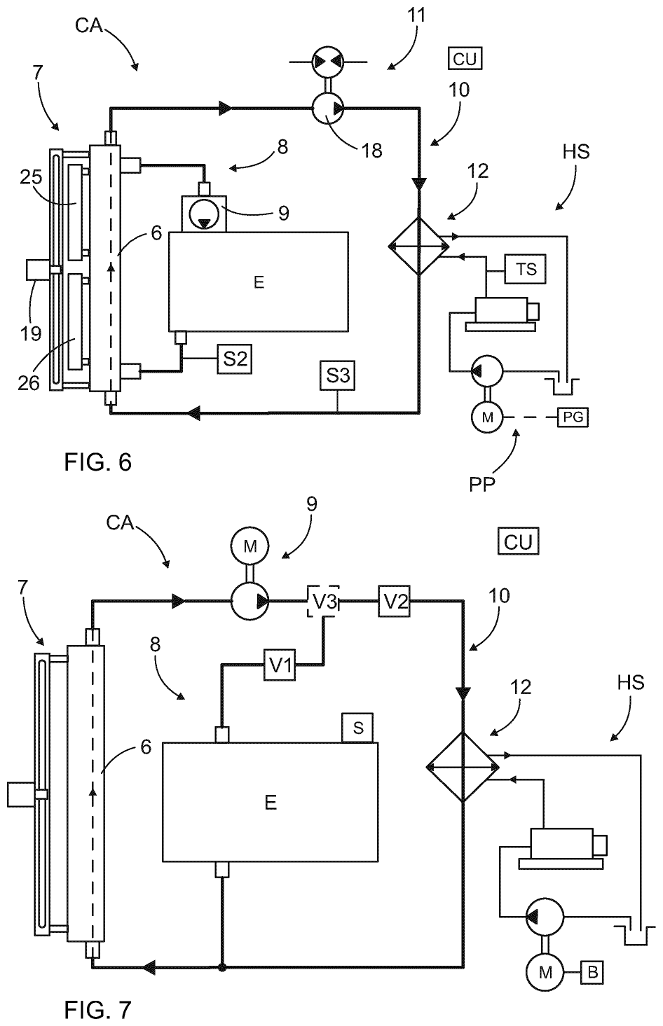

FIG. 5 discloses an alternative cooling arrangement CA which differs from the one disclosed in FIGS. 3 and 4 in that the second liquid cooling circuit 10 comprises only one control valve 17b. Further, the control valve 17b is hydraulically controlled whereas in FIGS. 3 and 4 the control valves are electrical valves. Another difference is that there is a second radiator 22 in connection with the first radiator 6 and being cooled by the same fan 7. Hydraulic oil returning from the hydraulic actuators, such as rock drilling machines 5, is at first cooled by the oil cooler 12 and is then conveyed through a channel 23 to the second radiator 22, which is an oil to air type radiator. Thereafter the hydraulic oil is conveyed through a channel 24 to the tank 21. There may be one or more filters between the second radiator 22 and the tank 21. In this embodiment there is a two-phase oil cooling arrangement.

Further, it is possible to direct part of the hydraulic fluid flow only through the oil cooler 12 and part of the flow only through the radiator 22. Thus, returning hydraulic fluid flow of an impact device of the rock drilling machine 5 may be directed to the oil cooler 12 and returning flow of a rotating device of the rock drilling machine 5 may be directed to the radiator 22, for example.

FIG. 6 discloses still another embodiment for the cooling arrangement CA. In this solution there is no control valves in the second liquid cooling circuit 10 but instead the pump 19 may serve as a flow blocking element when not being operated. Further, the pump 18 is rotated by means of a hydraulic motor. One more difference to the previously disclosed solutions is that there are totally three radiators, a first radiator 6 for cooling agent and two additional radiators 25, 26 utilizing cooling effect of the common fan 7. The additional radiators may be arranged to cool air fed to the engine E, motor oil of the engine, and hydraulic oil, for example.

There may be several radiators arranged adjacent to each other in vertical or horizontal direction. Different hydraulic circuits, or other circuits to be cooled, may be connected to these radiators in different ways depending on their cooling needs. It is also possible to connect two or more radiators together using serial or parallel connections between them.

FIG. 6 further discloses that temperature of the hydraulic fluid may be monitored by means of a temperature sensor TS. Sensing data from the temperature sensors and from the sensor S monitoring operating status of the combustion engine E, among possible other sensors, may be fed to the control unit CU for provided needed control data. In FIG. 6 the electrical power package PP is connected to a power grid PG instead, or in addition to, onboard mounted batteries.

FIG. 6 further discloses a sensor S2 for sensing properties of the cooling agent, such as temperature.

The control unit CU can control the second liquid cooling circuit 10 based on temperature sensing data of the cooling agent and the hydraulic oil i.e., on the basis of data received from the temperature sensor TS, or a temperature sensor S3, or from both sensors TS and S3. The control unit CU can control actuators and devices of the second liquid cooling circuit 10 based on the sensing data and the control may be either on/off or proportional type control. The control unit CU may also be provided data on whether the hydraulic system HS is operating or not.

FIG. 7 discloses a solution which differs from the previous solutions in that there is only one pump in the cooling arrangement CA for circulating the cooling agent in both liquid cooling circuits 8, 10. Thus, the first pump unit 9 may be driven independently of the combustion engine E. Flows generated by the first pump unit 9 can be controlled by means of valve elements V1, V2 connected to the liquid cooling circuits 8, 10 for controlling the flows in one circuit at a time. Alternatively, the flows may be controlled by means of one valve element V3, which may be a 3/2 or 4/2 directional control valve, for example. The valve elements V1 and V2 may be on/off control valves, for example. FIG. 7 discloses situation when the second liquid cooling circuit 10 is operative.

The drawings and the related description are only intended to illustrate the idea of the invention. In its details, the invention may vary within the scope of the claims.

1. A mining vehicle comprising:
a combustion engine arranged for executing tramming;
a hydraulic system arranged for powering at least one hydraulic actuator;
an electrically operable powerpack arranged for powering the hydraulic system; and
a cooling arrangement, wherein the cooling arrangement comprises:
a first liquid cooling circuit arranged for cooling the combustion engine and including at least one first radiator provided with a fan, and a first pump unit for circulating coolant agent between the combustion engine and the first radiator; and
at least one oil cooler arranged for cooling hydraulic oil of the hydraulic system;
a second liquid cooling circuit selectively connectable to the first liquid cooling circuit, whereby the same cooling agent, the at least one first radiator and the fan are implemented in both liquid cooling circuits, wherein the at least one oil cooler is a liquid to liquid cooler connected to the second liquid cooling circuit whereby heat of the hydraulic oil is transferred via the oil cooler to the coolant agent; and
a first cooling mode for circulating the coolant agent in the first liquid cooling circuit in response to detection that the combustion engine is operating, and a second cooling mode for circulating the coolant agent in the second liquid cooling circuit only in response to detection that the combustion engine is not operating.

2. The mining vehicle as claimed in claim 1, wherein the cooling arrangement further comprises at least one control unit for automatic control of the second liquid cooling circuit, wherein the control unit is provided with sensing data indicating an operating status of the combustion engine, and wherein the control unit is configured to control the second cooling mode on and off in response to the sensing data for controlling the second cooling circuit.

3. The mining vehicle as claimed in claim 1, wherein the second liquid cooling circuit includes at least one control valve for opening and closing circulation of the second liquid cooling circuit to the at least one radiator.

4. The mining vehicle as claimed in claim 1, wherein the fan of the first radiator includes a dedicated fan motor and is operable independently in relation to the operation of the combustion engine.

5. The mining vehicle as claimed in claim 1, wherein the second liquid cooling circuit includes at least one dedicated circulation pump unit for circulating the cooling agent in the second liquid cooling circuit.

6. The mining vehicle as claimed in claim 1, wherein the first pump unit is configured to circulate the coolant agent also in the second liquid cooling circuit.

7. The mining vehicle as claimed in claim 1, wherein the cooling arrangement includes at least one of the following temperature sensors for providing temperature sensing data for the control unit: a temperature sensor for sensing temperature of the cooling agent; and a temperature sensor for sensing temperature of the hydraulic oil, wherein the control unit is configured to control the second liquid cooling circuit in the second cooling mode in response to the received temperature data.

8. A rock drilling rig comprising:
a movable carrier;
a combustion engine and a transmission system for tramming the rock drilling rig;
a drilling boom mounted on the carrier and including a rock drilling unit provided with a hydraulic rock drilling machine;
a hydraulic system for powering at least hydraulic actuators of the rock drilling machine;
an electrically operable powerpack for powering at least the hydraulic system; and
a cooling arrangement according to claim 1, the cooling arrangement being arranged for cooling the combustion engine and hydraulic oil of the hydraulic system, wherein the cooling arrangement includes a second liquid cooling circuit arranged for cooling the hydraulic oil and being connectable to a first liquid cooling system of the combustion engine, whereby the cooling arrangement is configured to provide cooling alternately for the combustion engine or the hydraulic system.

9. A method for providing cooling in a mine vehicle, the method comprising:
cooling a combustion engine of the mine vehicle by means of a first liquid cooling circuit including at least one first radiator provided with a fan, and a first pump unit;
cooling hydraulic oil of a hydraulic system of the mine vehicle by means of at least one oil cooler, wherein the at least one oil cooler is a liquid to liquid cooler;
connecting the at least one oil cooler to a second liquid cooling circuit, whereby the same cooling agent, the first radiator and the fan are implemented in both the first and second liquid cooling circuits;
circulating the coolant agent in the first liquid cooling circuit in response to detection that the combustion engine is operating; and
connecting the second liquid cooling circuit selectively to the first liquid cooling circuit only in situations when the combustion engine requires no cooling and utilizing a cooling area of a radiator of the first liquid cooling circuit for cooling the hydraulic oil.

10. The method as claimed in claim 9, further comprising adjusting a flow rate of the cooling agent in the second liquid cooling circuit by means of a dedicated circulation pump unit of the second liquid cooling circuit.

11. The method as claimed in claim 9, further comprising pre-cooling the hydraulic oil prior to initiating operation of at least one hydraulic actuator of the hydraulic system.

12. The method as claimed in claim 9, further comprising running a common fan of the first and second liquid cooling circuits independently of the operation of the combustion engine.

13. The method as claimed in claim 9, further comprising sensing temperature of at least one of the following: cooling agent, hydraulic oil, and providing the control unit with the sensed temperature data and controlling the second liquid cooling circuit in response to the received temperature data in situations when the combustion engine requires no cooling.
